(19) United States
(12) Patent Application Publication
(10) Pub. No.: US 2006/0050292 A1
(43) Pub. Date: Mar. 9, 2006

(54) Data management device and method, image output device, and computer program product

(75) Inventors: Takeshi Morikawa, Takarazuka-shi (JP); Daisetsu Tohyama, Amagasaki-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/006,571

(22) Filed: Dec. 8, 2004

(30) Foreign Application Priority Data
Sep. 8, 2004 (JP) 2004-261173

(51) Int. Cl. G06F 3/12

(52) U.S. Cl. 358/1.13

(57) ABSTRACT

A data management device such as an image forming device is provided in which usability for handling data stored in boxes is improved. The image forming device includes a hard disk for storing files including image data, an active job database for storing job information about a job of an image output process, a job list generation portion for generating an active job operation screen for letting a user select any one of jobs and producing the screen for the user, a file search portion for searching a file having connection with the job selected by the user on the active job operation screen from the hard disk, and a file list generation portion for producing a file confirmation screen including a list of the searched files for the user.

This application is based on Japanese Patent Application No. 2004-261173 filed on Sep. 8, 2004, the contents of which are hereby incorporated by reference.

### BACKGROUND OF THE INVENTION

1. Field of the Invention

The present invention relates to handling of data stored in a storage medium such as a hard disk. More specifically, the present invention relates to handling of image data that are used in an image output device such as an MFP.

2. Description of the Prior Art

Recently, an image forming device called a multifunction device or a multifunction peripheral (MFP) has been becoming commonplace. It has functions of a copy machine, a scanner, a fax machine, a network printer and a document server. The function of the document server provides a storage area called a “personal box” or a “box” for each user in a storage medium such as a hard disk. Then, each user can store various data in his or her box. For example, the user can store image data of an image to be printed by the image forming device or image data to be sent from the image forming device to another device.

Along with many functions of the image forming device and a large capacity of a hard disk, various data of a large quantity can be stored in the box. As a result, users have requested to improve usability of the box. Therefore, several methods are proposed in patent publications as shown below.

Japanese unexamined patent publication No. 2001-256013 teaches a method in which all the print jobs corresponding to the same condition for grouping are compiled into one group. Then, these print jobs are executed consecutively without being interrupted by another print job.

Japanese unexamined patent publication No. 2003-85159 teaches a method in which an HTML document file is analyzed to generate an abstract tree structure, so that positions of printing objects to be drawn are determined. Links of chapters and sections in a leading HTML document are detected so that HTML documents of chapters and sections are read. The similar process is performed for each of the HTML documents of chapters and sections. Table of contents information with page numbers is produced in accordance with positions and sizes of the objects. The print position of each object is determined again in accordance with the table of contents information so as to produce print data. Then, the table of contents and print data of chapters and sections are made one print file, and a request to print is sent to a printer.

Japanese unexamined patent publication No. 2003-316560 teaches a method in which when updating a job list, a file name stored in a hot folder is compared with a file name described in the job list. A file name that is stored in the hot folder but is not described in the job list is added to the job list.

Japanese unexamined patent publication No. 2003-84941 teaches a method in which a plurality of jobs is selected from a box area. After clearing process modes of these jobs, a new process mode is set again.

However, usability in the conventional method is not good when registering a job for an output process of an image or the like in a queue and then data of another image connected to the job is searched from the box so as to perform a process for the data.

For example, when the user registers an output job of an image in a queue, and after that wants an output of another image of the same type together with the former image, the user has to abandon the job. Then, the user has to find data of the image and data of another image to be produced together from the box so that these data are compiled into one group to be registered again as a job.

### SUMMARY OF THE INVENTION

An object of the present invention is to improve usability when handling a job stored in a queue or data stored in a box compared with the conventional method.

A data management device according to one aspect of the present invention, which is a data management device for managing data that are used for performing a process, includes a data storage portion for storing the data, a job information storage portion for storing job information about a job of the process, a job list display portion for performing a process for displaying a job list screen in accordance with the job information stored in the job information storage portion, the job list screen being used for letting a user select a job, a data searching portion for searching data having connection with the job selected by the user on the job list screen from the data stored in the data storage portion in accordance with the job information of the job, and a data list display portion for performing a process for displaying a data list screen that is a list of the data searched by the data searching portion.

Alternatively, the data management device can be structured as follows. The data list display portion performs a process for displaying a data list screen for letting a user select any of the data stored in the data storage portion. There is provided a job searching portion that searches a job having connection with the data selected by the user on the data list screen in accordance with the job information stored in the job information storage portion as well as a job process portion that performs a process designated by the user for the job searched by the job searching portion.

The data management device can be applied to an image output device such as an MFP. In this case, the data storage portion stores output data for outputting an image as the data. The job information storage portion stores job information about a job of the image output process.

In the present invention, to “bind” a job to another job means to compile these jobs into one group so that a predetermined process can be performed as one job.

According to one aspect of the present invention, usability of handling a job stored in a queue or data stored in a storage portion such as a box can be improved compared with the conventional method.

According to another aspect of the present invention, it is easy operation to bind a job selected by a user and waiting in a queue to another job of an image output process of data having connection with the job. According to still another aspect of the present invention, it is easy operation to bind a job of an image output process selected by a user to another job waiting in a queue having connection with the job.

### BRIEF DESCRIPTION OF THE DRAWINGS

FIG. 1 shows an example of an overall structure of a file sharing system.

FIG. 2(a) shows an example of an external view of an image forming device.

FIG. 2(b) shows an example of a hardware structure of the image forming device.

FIG. 3 shows an example of a box or the like provided to a hard disk.

FIG. 4 shows an example of a structure of a file.

FIG. 5 shows an example of a user information database.

FIG. 6 shows an example of a job history database.

FIG. 7 shows an example of a functional structure of the image forming device.

FIG. 8 shows an example of an active job database.

FIG. 9 is a flowchart showing an example of a flow of a general process of the image forming device.

FIG. 10 shows an example of an initial menu screen.

FIG. 11 is a flowchart showing an example of a flow of a process for designating a box or the like.

FIG. 12 shows an example of a user selection screen.

FIG. 13 shows an example of a password input screen.

FIG. 14 shows an example of a file name input screen.

FIG. 15 shows an example of a user selection screen.

FIG. 16 shows an example of a password input screen.

FIG. 17 shows an example of a file name input screen.

FIGS. 18 and 19 are flowcharts showing an example of a flow of a job operation process in a first embodiment.

FIG. 20 shows an example of an active job operation screen.

FIG. 21 is a flowchart showing an example of a flow of a related file search process.

FIG. 22 shows an example of a file confirmation screen.

FIG. 23 shows an example of a result confirmation screen.

FIG. 24 is a flowchart showing an example of a flow of a job operation process.

FIG. 25 shows an example of a file operation screen.

FIG. 26 is a flowchart showing an example of a flow of a related job operation process.

### DESCRIPTION OF THE PREFERRED EMBODIMENTS

Hereinafter, the present invention will be explained in more detail with reference to embodiments and drawings.

### First Embodiment

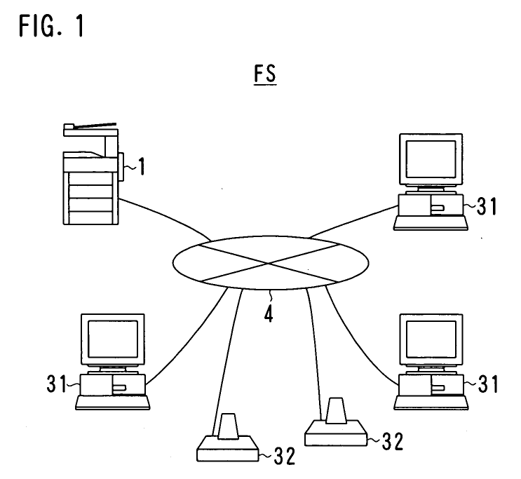

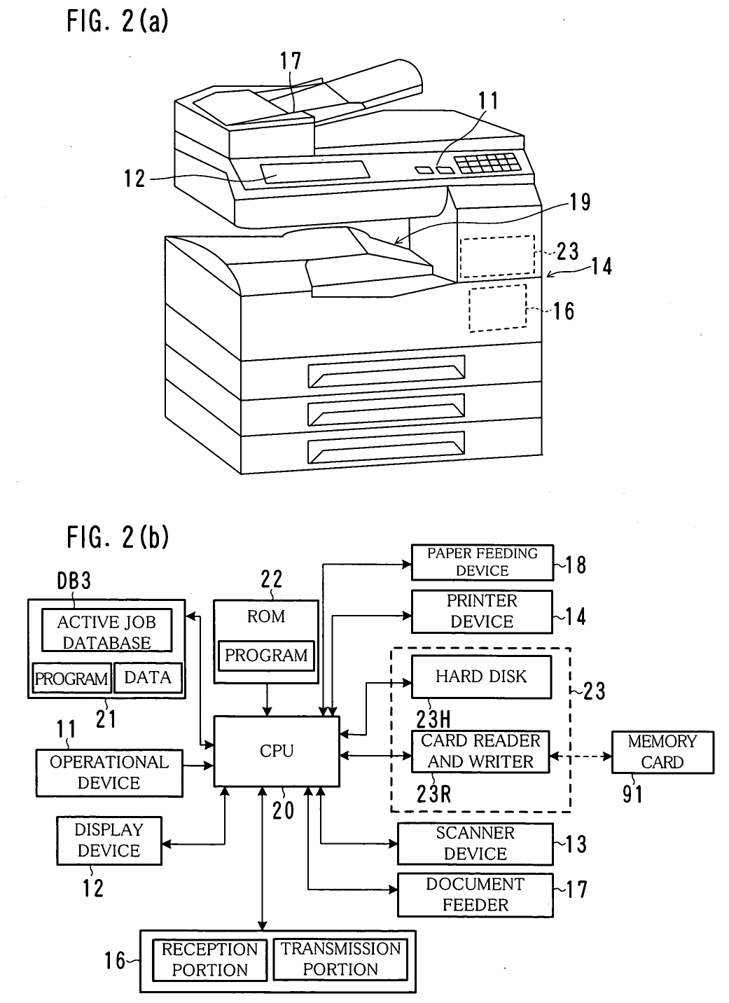

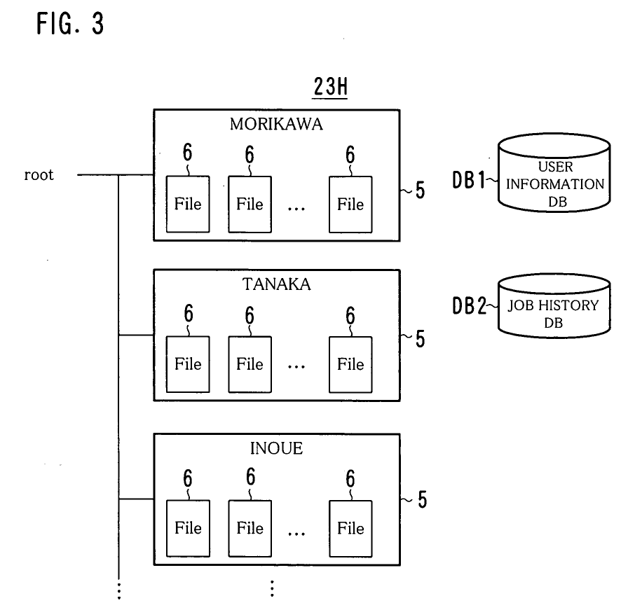

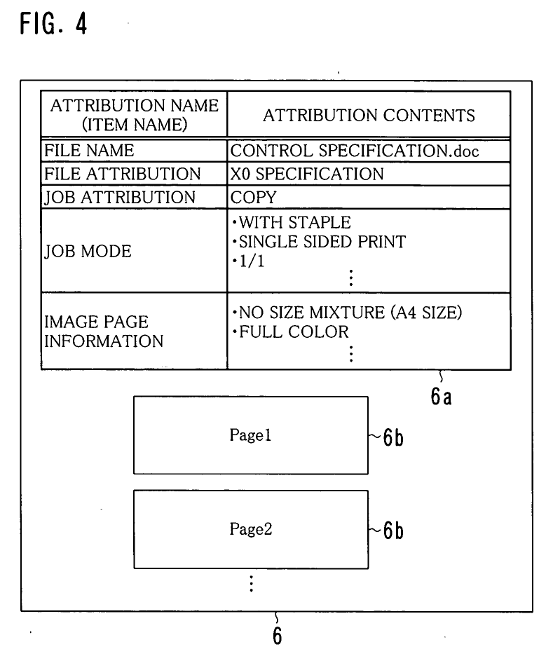

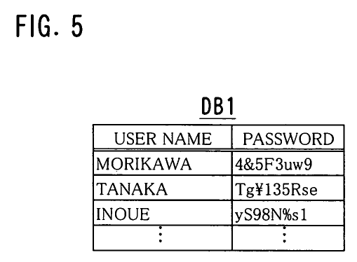

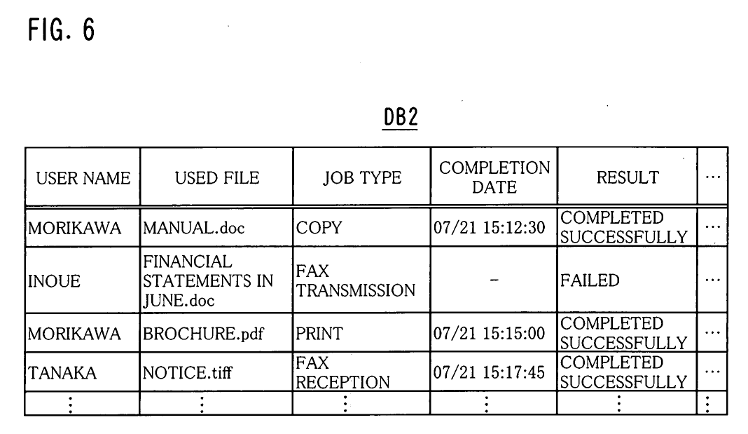

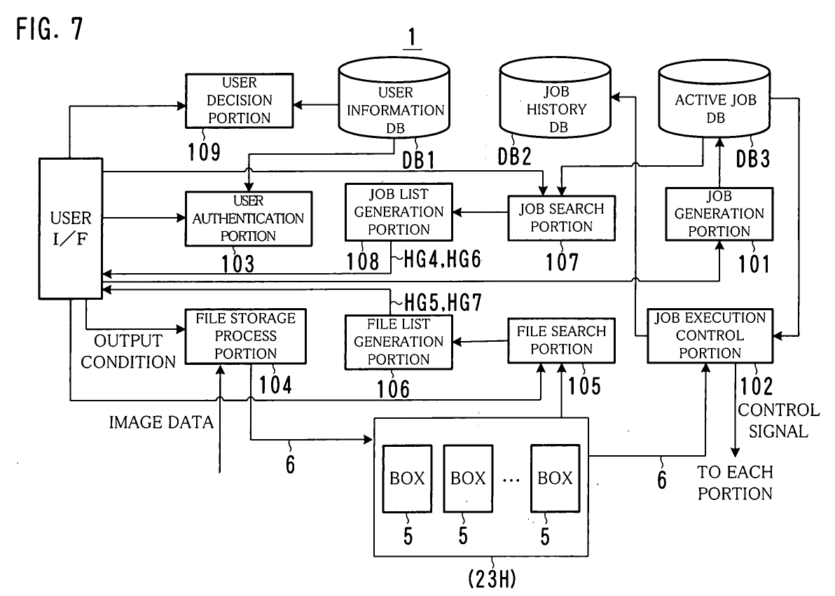

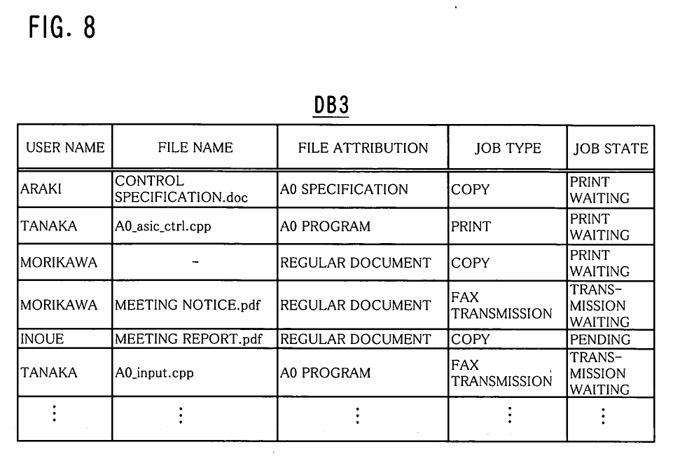

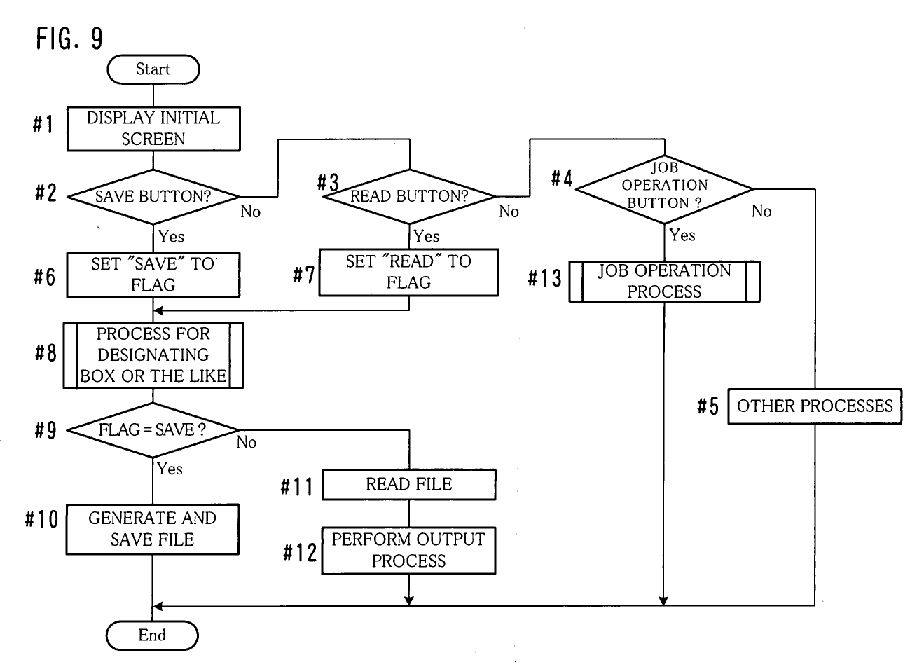

FIG. 1 shows an example of an overall structure of a file sharing system FS, FIGS. 2(a) and 2(b) show an example of an external view and a hardware structure of an image forming device 1 respectively, FIG. 3 shows an example of a box 5 or the like provided to a hard disk 23H, FIG. 4 shows an example of a structure of a file 6, FIG. 5 shows an example of a user information database DB1, FIG. 6 shows an example of a job history database DB2, FIG. 7 shows an example of a functional structure of the image forming device 1, and FIG. 8 shows an example of an active job database DB3.

As shown in FIG. 1, the file sharing system FS includes the image forming device 1 of the present invention, one or more personal computers 31, one or more FAX terminals 32 and a communication line 4. The image forming device 1 and each of the personal computers 31 are given identification information such as an IP address for identifying each of them. Each of the FAX terminals 32 is given a telephone number of a so-called fixed telephone or an IP telephone.

The image forming device 1, each of the personal computers 31 and each of the FAX terminals 32 can be connected to one another via the communication line 4. As the communication line 4, a LAN, the Internet, a private line or a public telephone line can be used. As a communication protocol or a communication standard, TCP/IP (Transmission Control Protocol/Internet Protocol), FTP (File Transfer Protocol), POP3 (Post Office Protocol version 3), SMTP (Simple Mail Transfer Protocol), IPP (Internet Printing Protocol), IEEE802.3 for a wired LAN, IEEE802.11 for a wireless LAN, G3 (Group 3) standard or G4 (Group 4) standard for FAX, or the like can be used.

According to this file sharing system FS, a user can share data stored in a hard disk of the image forming device 1 between the image forming device 1 and the personal computer 31. Instead of the personal computer 31, a workstation, a PDA (Personal Digital Assistant), a cellular phone or the like can be used.

The image forming device 1 is a device in which a copy, a network printing, a scanner, a FAX, a document server and other functions are integrated. It is also called a multifunction device or an MFP (Multi Function Peripheral).

This image forming device 1 includes a operational device 11, a display device 12, a scanner device 13, a printer device 14, a communication interface 16, a document feeder 17, a paper feeding device 18, a tray 19, a CPU 20, a RAM 21, a ROM 22 and a data memory portion 23 as shown in the external view of FIG. 2(a) and in the hardware structure of FIG. 2(b).

The operational device 11 includes a plurality of keys for entering numbers, characters, symbols or the like, a sensor for recognizing a pressed key and a transmission circuit for transmitting a signal indicating a recognized key to the CPU 20.

The display device 12 displays a screen for giving the user a message or an instruction, a screen for the user to enter setting contents or process contents and a screen for indicating an image formed by the image forming device 1 and a result of the process. In this embodiment, a touch panel is used as the display device 12. Therefore, the display device 12 has a function of detecting a position on the touch panel where the user's finger touched and sending a signal of the detection result to the CPU 20.

In this way, the operational device 11 and the display device 12 work as a user interface for the user to operate the image forming device 1 directly. Note that an application program and a driver for giving instructions to the image forming device 1 are installed in the personal computer 31. Therefore, the user can operate the image forming device 1 also from a remote place by using the personal computer 31.

The scanner device 13 reads images including photographs, characters, pictures and charts on an original optically and generates digital image data (i.e., density data indicating density of RGB or black, here). The obtained image data are used by the printer device 14 for printing. Alternatively, the image data are converted into a file of a format such as TIFF (Tagged Image File Format) or PDF (Portable Document Format) and are stored in the data memory portion 23 or sent to the personal computer 31. Alternatively, the image data are converted into FAX data and are sent to the FAX terminal 32. The document feeder 17 is disposed at the upper portion of a main body of the image forming device 1 and is used for feeding one or more sheets of original to the scanner device 13 sequentially.

The printer device 14 prints an image read by the scanner device 13, an image of image data sent from the personal computer 31, an image of FAX data sent from the FAX terminal 32 on a record sheet such as paper or film. The paper feeding device 18 is disposed at the lower portion of the main body of the image forming device 1 and is used for supplying record sheets suitable for the image to be printed to the printer device 14. The record sheet on which the image is printed by the printer device 14, i.e., a printed matter is ejected into the tray 19.

The communication interface 16 includes a transmission portion and a reception portion, and is used for sending or receiving data to/from the personal computer 31 or the FAX terminal 32. As the communication interface 16, an NIC (Network Interface Card), a modem, a TA (Terminal Adapter), or the like can be used.

The data memory portion 23 includes a hard disk 23H and a card reader and writer 23R. The card reader and writer 23R reads data from a memory card 91 such as a compact flash (a registered trade mark) or a smart media, or writes data into the memory card 91. The memory card 91 is used mainly for exchanging data with the personal computer 31 without using the communication line 4 or for backup of data.

The hard disk 23H includes personal boxes each of which is assigned to each user as a storage area for storing each user's data as a file 6 as shown in FIG. 3. The personal box corresponds to a “directory” or “folder” in a personal computer or a workstation. Hereinafter this personal box is referred to as a “box 5”. The box 5 is associated with a box name for being discriminated from other boxes 5. In this embodiment, a user name of the user who is an owner of the box is used as the box name.

The user can store the file 6 in the box 5 by file transmission from the personal computer 31. Alternatively, the memory card 91 storing the file 6 may be set to the slot of the card reader and writer 23R and file copy may be executed for storing the file in the box 5. Other than that, the file 6 can be stored in the box 5 in the following case.

For example, when the user makes an instruction to copy an original set to the document feeder 17, the image forming device 1 converts image data of the image read from the original into the file 6 and stores the same in the box 5 of the user. Similarly, when an instruction to send image data of an image of an original set to the document feeder 17 to the personal computer 31 is made, the image data of the read image is converted into the file 6, which is stored in the box 5 of the user. When the personal computer 31 of the user issues an instruction to print a document (network printing), image data of the document sent from the personal computer 31 is stored as the file 6 in the box 5 of the user. When FAX data are transmitted from the FAX terminal 32, the FAX data are stored as the file 6 in the box 5 of the user who is a receiver. When an instruction to transmit an image of an original set to the document feeder 17 to the FAX terminal 32 is made, the image data of the read image are converted into the file 6, which is stored in the box 5 of the user.

The file 6 stored in the box 5 includes attribution information 6a and real image data 6b as shown in FIG. 4. The attribution information 6a indicates attribution of the file 6. The real image data 6b are data of contents (images, texts, charts or the like) of pages constituting the document of the file 6.

The “file name” of the attribution information 6a is identification information for discriminating the file 6 from other files 6 stored in the same box 5. Therefore, plural files 6 having the same file name cannot be stored in the same box 5, but it is possible to store them in different boxes 5. The “file attribution” is information for classifying contents of the document of the file 6, and the user can determine it for his or her convenience.

The “job attribution” indicates which type of process the file 6 is used to perform. Namely, a value of the job attribution is determined in accordance with which instruction the user made and how the file 6 was stored in the box 5.

In the example shown in FIG. 4, the job attribution indicates a value of “copy”. This means that the file 6 is a file for copying an original and was generated by file conversion of image data of an image read from the original in accordance with the copy instruction by the user and was stored in the box 5.

Furthermore, the job attribution may indicate a value such as “scan”, “print”, “FAX transmission”, or “FAX reception”. The value “scan” means that the file 6 is a file for transmitting an image of a scanned original to the personal computer 31 and was generated by file conversion of image data of an image read from the original in accordance with the user's scan instruction and was stored in the box 5. The value “print” means that the file 6 is a file for printing an image of a document prepared in the personal computer 31 and was obtained from the personal computer 31 in accordance with the user's print instruction and was stored in the box 5. The value “FAX transmission” means that the file 6 is a file for transmitting an image of a scanned original to the FAX terminal 32 and was generated by file conversion of image data of an image read from the original in accordance with the user's FAX transmission instruction into a FAX format and was stored in the box 5. The “FAX reception” means that the file 6 is a file for printing an image received from the FAX terminal 32 and was generated by file conversion of FAX data of the received image and was stored in the box 5.

A “job mode” of the attribution information 6a indicates which condition is to be used for performing the process indicated in the “job attribution”. In the example shown in FIG. 4, it means that the copy process should be performed in the conditions such that a finish of the printed matter is “with staples”, a print on a record sheet is “single sided print”, and a magnification is “1”. Furthermore, it is possible to set various conditions including color or monochrome print, a density, a finish with punch holes, the number of printed copies and a destination of transmission as the “job mode”.

The “image page information” of the attribution information 6a indicates attribution of the real image data 6b. For example, it indicates attribution about a print size and a print color of the page of the real image data 6b.

Note that the above-mentioned values are not set in the job attribution and the job mode of the file 6 that was simply transmitted from the personal computer 31 or duplicated from the memory card 91.

Furthermore, the hard disk 23H stores a user information database DB1 and a job history database DB2.

The user information database DB1 stores information about users who use the image forming device 1 as shown in FIG. 5. A “user name” is identification information for identifying each user. This user name is used when a user logs in the image forming device 1. A “password” is information for user authentication (user confirmation) when a user logs in.

The job history database DB2 stores information about processes (jobs) that were performed by the image forming device 1 and processes that could not be performed by the image forming device 1 (namely, that failed) as shown in FIG. 6. The “user name” indicates a user name of the user who made the instruction of the process. However, in the case of a process of FAX reception, it indicates a user name of a user who is a receiver. A “job type” indicates a type of the completed process or the failed process. A “used file” indicates a file name of the file 6 of the data that were used in the process. A “completion date” indicates a date and time when the process is completed. A “result” indicates whether the process was completed successfully or failed.

With reference to FIG. 2 again, the ROM 22 stores a program and data for realizing basic functions of the image forming device 1 including a reading (scanning) function of an image, a copy function of an original, a sending and receiving function of FAX data, a network printing function and a document server function (a box function). Furthermore, it stores a program and data for realizing functions of a job generation portion 161, a job execution control portion 102, a user authentication portion 103, a file storage process portion 104, a file search portion 105, a file list generation portion 106, a job search portion 107, a job list generation portion 108 and a user decision portion 109 as shown in FIG. 7. A part or the whole of the program or the data may be installed in the data memory portion 23. In this case, the program or the data installed in the data memory portion 23 may be loaded into the RAM 21 if necessary. Alternatively, a part or the whole of these functions may be realized by a processor (a circuit).

The RAM 21 stores temporarily data received from the personal computer 31 or the FAX terminal 32, data to be sent to the personal computer 31 or to the FAX terminal 32 and data generated by the scanner device 13. A nonvolatile RAM may be used as the RAM 21.

In addition, the RAM 21 stores an active job database DB3. This active job database DB3 stores information about processes (jobs) waiting for execution as shown in FIG. 8. Namely, the active job database DB3 is information indicating a queue. As a general rule, a job positioned in the upper line is executed first.

The “user name” indicates a user name of a user who made the request for the job. The “job type” indicates a type of the job. A “job state” indicates a present state of the job. The “job state” of a job that can be executed promptly when it becomes the turn of the job stores a value of “ . . . waiting”. A value of “pending” is stored in the “job state” of the job whose process is temporarily suspended. In this case, even if it becomes this job's turn, execution is skipped until the pending state is canceled.

The CPU 20 executes the program stored in the ROM 22 or the program loaded into the RAM 21 and controls the entire of the image forming device 1.

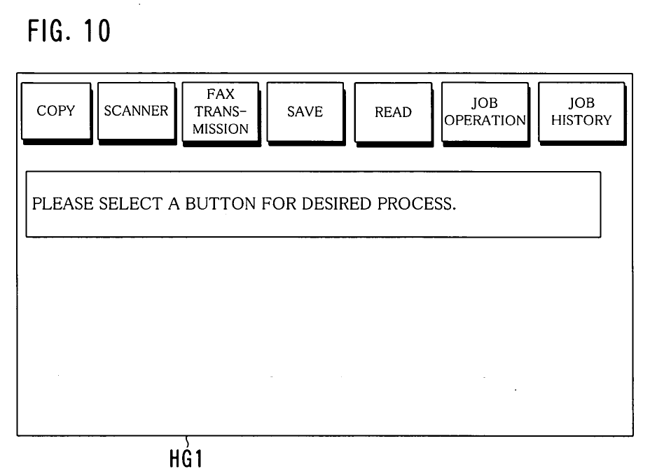

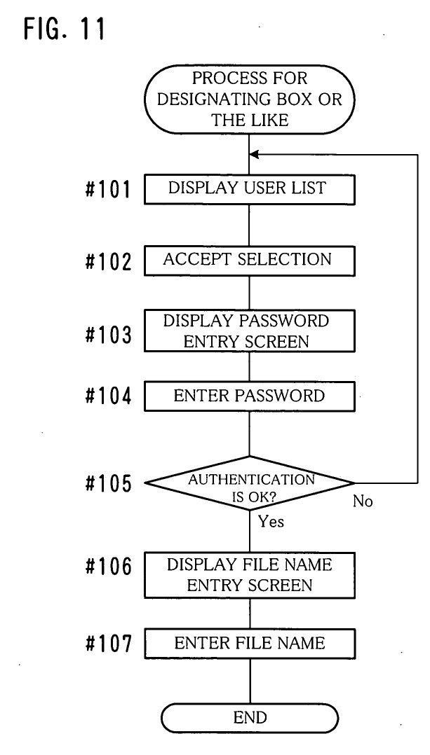

FIG. 9 is a flowchart showing an example of a flow of a general process of the image forming device 1, and FIG. 10 shows an example of an initial menu screen HG1.

Next, functions of the portions and contents of processes in the image forming device 1 shown in FIG. 7 will be described. The job generation portion 101 generates a job for performing a process instructed to the image forming device 1 by a user operating the operational device 11, the display device 12, the personal computer 31 or the FAX terminal 32 and registers the job in the active job database DB3 shown in FIG. 8. The job execution control portion 102 controls the portions of the image forming device 1 so that the job is executed in accordance with the queue of the active job database DB3. The user authentication portion 103 performs user authentication of a user who is letting the image forming device 1 perform a predetermined process.

The file storage process portion 104 generates the file 6 from image data obtained by the scan process of the scanner device 13, print data sent from the personal computer 31 or FAX data sent from the FAX terminal 32, each of the data being sent along with an instruction to execute a job made by a user. Then, the file is stored in the predetermined box 5.

The file search portion 105 searches a file 6 that satisfies a predetermined condition from the box 5. The file list generation portion 106 generates a list of the searched files 6. The job search portion 107 searches a job that satisfies a predetermined condition from the active job database DB3. The job list generation portion 108 generates a list of the searched jobs. The user decision portion 109 decides who is the user operating the image forming device 1.

The functions from the job generation portion 101 through the user decision portion 109 and contents of the processes will be described in more detail with reference to the flowchart shown in FIG. 9 and others. Note that a program for realizing processes of the flowcharts are stored in the ROM 22 or the hard disk 23H, and the CPU 20 controls the portions of the image forming device 1 in accordance with the program so that operations of the flowcharts are performed.

The display device 12 of the image forming device 1 displays the initial menu screen HG1 as shown in FIG. 10 when nobody is operating the image forming device 1 directly (#1 in FIG. 9). A user who is going to let the image forming device 1 perform a process presses and selects a button corresponding to the desired process on the initial menu screen HG1.

If a “copy” button, a “scanner” button or a “FAX transmission” button is selected (No in all the Steps #2-#4), a screen for designating a condition of the process corresponding to the button (Hereinafter referred to as a “process condition designation screen”) is displayed, and the user is invited to enter the condition. Then, if the condition is entered, the job generation portion 101 generates a job for performing the process selected on the initial menu screen HG1 in accordance with the condition, and the job is registered in the active job database DB3 (see FIG. 8). The job execution control portion 102 controls each of the portions so that the job is executed when its turn comes (#5).

For example, when the “copy” button is selected, the display device 12 is controlled to display a process condition designation screen for designating conditions including the number of copies, a scaling ratio, a density, a color print or a monochrome print, a double sided print or not and a finish (with or without staples and punch holes). The job generation portion 101 generates a job for performing copy under the condition of the designated contents and registers the job in the active job database DB3. Then, the job execution control portion 102 controls the scanner device 13 or the like so as to read an image of an original set to the document feeder 17 when the job's turn comes in accordance with the condition designated by the user and controls the printer device 14 so as to print the image on the record sheet.

If the “scanner” button is selected, a process condition designation screen is displayed for designating conditions including image quality for reading, a density for reading, whether or not an original is a double sided original, a format for converting the read image data into a file (TIFF, PDF or the like) and a destination of transmission of the converted file. Then, similarly to the above case of copy, a job is registered in the active job database DB3. When it comes a turn of the job, the scanner device 13 or the like is controlled so that an image of an original set to the document feeder 17 is read so as to generate an image file in accordance with the condition designated by the user, and the communication interface 16 is controlled to send the file to the designated destination.

If the “FAX transmission” button is selected, a process condition designation screen is displayed for designating conditions including a telephone number of a transmission destination, image quality for reading, a density for reading and whether or not an original is a double sided original. Then, similarly to the above case of copy or the like, when it comes a turn of the job, the scanner device 13 or the like is controlled so as to read an image of an original set to the document feeder 17 and to generate FAX data in accordance with the condition designated by the user, and the communication interface 16 is controlled so as to send the FAX data.

If a “job history” button is selected, a list of jobs that were performed and jobs that failed is displayed on the display device 12 in accordance with information stored in the job history database DB2 shown in FIG. 6.

Note that the user can let the image forming device 1 perform the print process by remote control using the personal computer 31. For example, the user opens an image file to be printed and enters a predetermined command after designating a print condition. Then, data for printing the image are transmitted from the personal computer 31 to the image forming device 1 together with information indicating the print condition. When the image forming device 1 receives these data, the job of the print process is registered in the active job database DB3, and the print process is performed by the printer device 14 or the like when it comes the job's turn similarly to the case of copy described above.

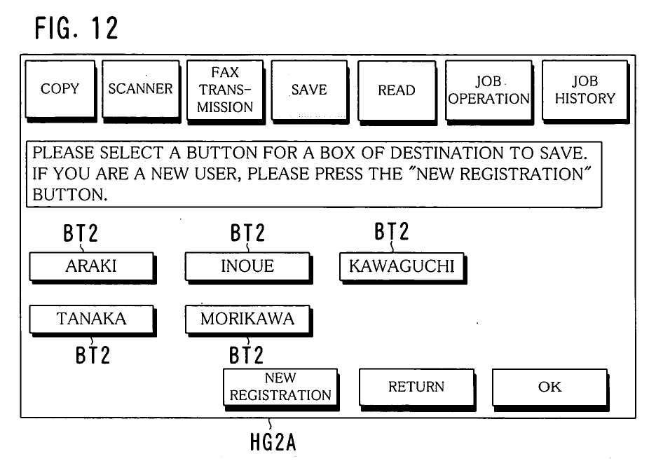

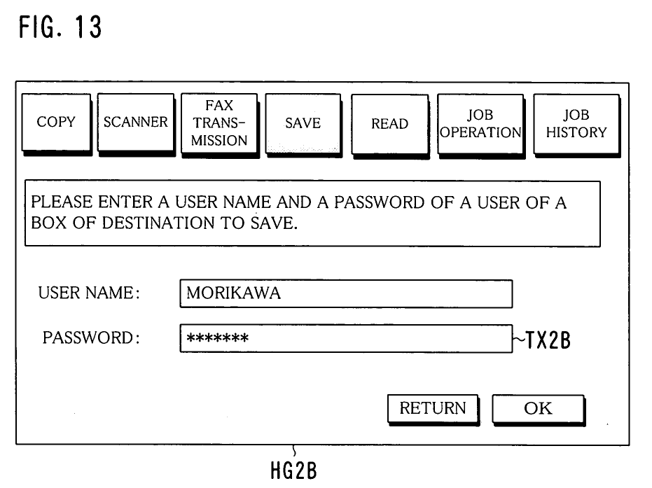

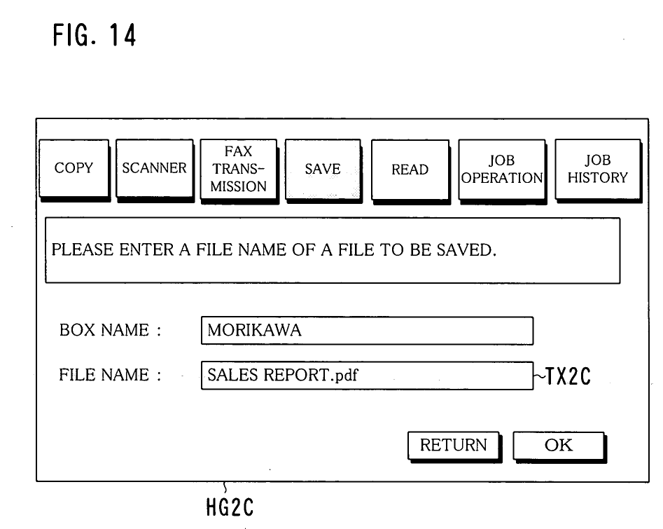

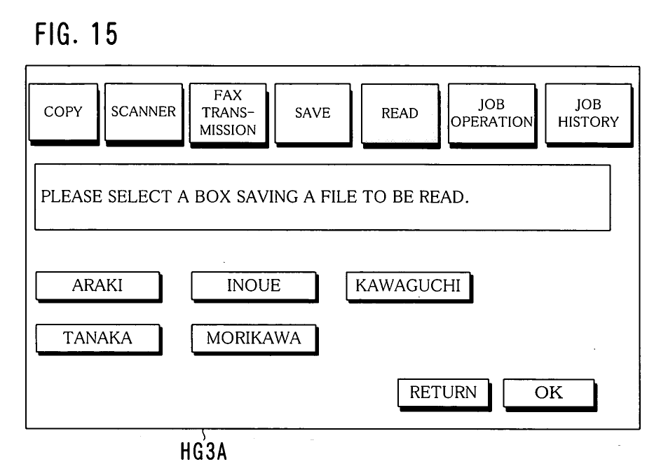

FIG. 11 is a flowchart showing an example of a flow of a process for designating a box or the like, FIG. 12 shows an example of a user selection screen HG2A, FIG. 13 shows an example of a password input screen HG2B, and FIG. 14 shows an example of a file name input screen HG2C.

With reference to FIG. 9 again, when the user selects any one of the “copy” button, the “scanner” button and the “FAX transmission” button on the initial menu screen HG1, if a “save” button is also pressed (Yes in #2), the file storage process portion 104 shown in FIG. 7 generates the file 6 for performing a process corresponding to the selected button and stores the file 6 in the box 5. The generation and the save of the file 6 are performed as follows.

A value “save” is set to a process flag for indicating a state (a type) of the process to be performed (#6). A process for designating a file name of the file 6 to be saved and a box 5 as a destination to save is performed by the procedure shown in FIG. 11 (#8).

Namely, the user selection screen HG2A shown in FIG. 12 is displayed on the display device 12 first (#101). Here, the user finds a user selection button BT2 indicating his or her user name and presses it to select the same. When the selected user selection button BT2 is accepted (#102), the password input screen HG2B shown in FIG. 13 is displayed (#103). Here, the user operates a key of the operational device 11 so as to enter his or her password in a text box TX2B and presses an “OK” button. Note that FIG. 13 shows an example of the password input screen HG2B when a “MORIKAWA” button is pressed in the user selection screen HG2A shown in FIG. 12.

When the entered password is accepted (#104), the user authentication portion 103 is requested to perform the user authentication process. The user authentication portion 103 retrieves a password of the user selected on the user selection screen HG2A from the user information database DB1 (see FIG. 5) and compares the retrieved password with the accepted password so as to decide whether or not the user operating the image forming device 1 is a correct user (#105).

If it is decided to be the correct user (Yes in #105), the log-in process of the image forming device 1 for the user is completed, and the file name input screen HG2C shown in FIG. 14 is displayed (#106). Here, the user determines a file name of the file to be saved, enters the file name in a text box TX2C, and presses the “OK” button. Thus, the entered file name is accepted (#107). If it was not decided to be a correct user because the passwords are not identical to each other, (No in #105), an error message is displayed for inviting the user to select a user name and enter the password again.

Thus, a storage place and a file name of the file 6 to be saved are designated. Namely, the box 5 corresponding to the user name accepted in Step #102 becomes the storage place of the file 6, and the file name accepted in Step #107 becomes the file name of the file 6.

Note that if a “return” button is pressed on each of the above-mentioned screens shown in FIGS. 12, 13 and 14 or on each of screens described below, the screen of the initial menu screen HG1 is displayed again. Then, the user can operate the selection of each item or the like from the beginning.

With reference to FIG. 9 again, the file storage process portion 104 generates the file 6 for performing the process selected on the initial menu screen HG1, attaches the file name designated in Step #8 to the file 6, and saves the file 6 in the box 5 designated in Step #8 (Yes in #9, #10). The procedure for generating the file 6 is almost the same as a part of the procedure in the process described in Step #5.

For example, when the “copy” button is selected, a screen for designating the conditions including the number of copies and file attribution is displayed. An image of an original is read in accordance with contents designated by the user. Data of the image of the read original is converted into the real image data 6b of a predetermined format (see FIG. 4), and the attribution information 6a is generated in accordance with the designated contents. Then, the attribution information 6a and the real image data 6b are compiled into one group so as to generate the file 6. If the “scanner” button is selected, a screen for designating conditions including the image quality for reading and the file attribution is displayed. An image of an original is read in accordance with the designated contents. Then, similarly to the case where the “copy” button is selected, the attribution information 6a and the real image data 6b of the image of the read original are generated and compiled into one group to generate the file 6. If the “FAX transmission” button is selected, a screen for designating conditions including a telephone number of a transmission destination and file attribution is displayed. An image of an original is read so as to generate the real image data 6b for FAX transmission in accordance with the designated contents. Then, the attribution information 6a and the real image data 6b are generated, and the file 6 is generated.

Note that it is possible not only to generate the file 6 for performing the process corresponding to the button selected from the initial menu screen HG1 and save the file 6 in the box 5, but also to perform the process promptly. Alternatively, it is possible not to perform the process here, but to perform the process later when a user makes the instruction. It is preferable that a user can select whether or not to perform the process promptly.

In addition, the user can store the file 6 for printing the image generated by the personal computer 31 by using the image forming device 1 in his or her box 5. In this case, the user selects an option corresponding to the “save” button on the initial menu screen HG1 when entering a command of the print process. Then, the file storage process portion 104 converts the print data received from the personal computer 31 into a file so as to generate the file 6, which is saved in the box 5 of the user.

When the user finishes using the image forming device 1, the user performs a predetermined operation to log out of the image forming device 1. In addition, it is possible to perform the log out forcibly after a period of no operation has continued over a predetermined time.

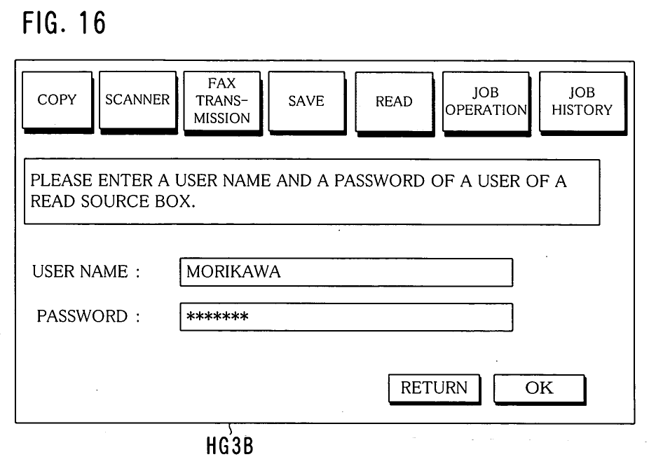

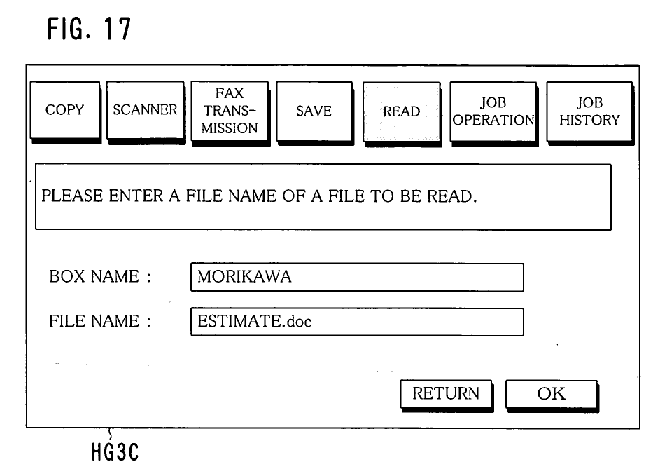

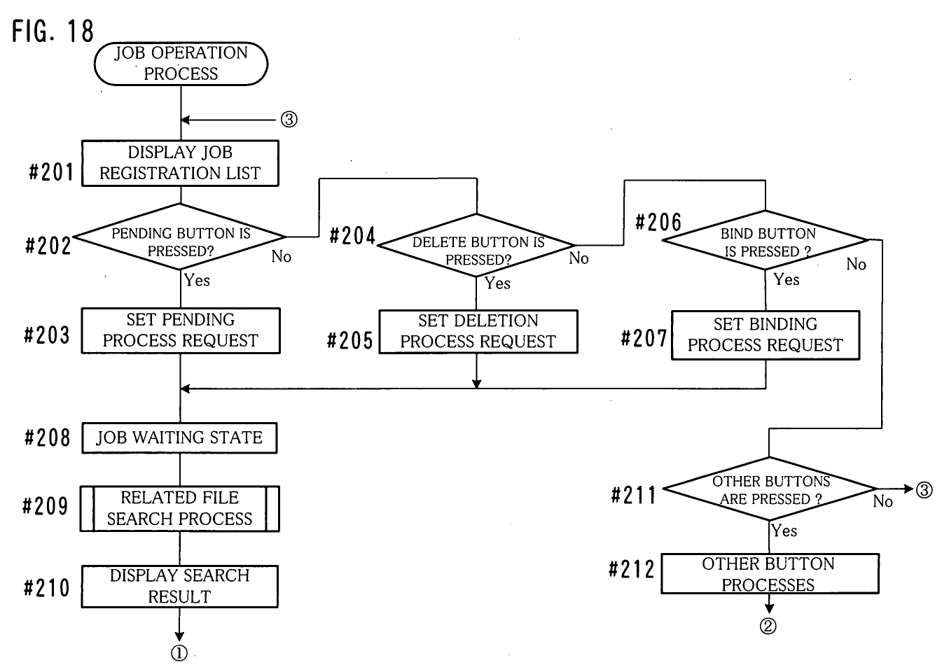

FIG. 15 shows an example of a user selection screen HG3A, FIG. 16 shows an example of a password input screen HG3B, and FIG. 17 shows an example of a file name input screen HG3C.

The user can read the file 6 that was stored in the box 5 by the process in Steps #6, #8, #9 and #10 shown in FIG. 9 and let the image forming device 1 perform the desired process. In this case, the image forming device 1 performs the process by the following procedure.

When the user selects a “read” button on the initial menu screen HG1 shown in FIG. 10 (No in #2, Yes in #3), a value “read” is set to the process flag (#7), and the user's designation of the file 6 to be read out is accepted (#8). This procedure is basically the same as the case described above where the storage place and the file name are designated in the process for saving the file 6, which is shown in FIG. 11. However, in Steps #101, #103 and #106 of FIG. 11, the user selection screen HG2A shown in FIG. 12, the password input screen HG2B shown in FIG. 13 and the file name input screen HG2C shown in FIG. 14 are replaced with the user selection screen HG3A shown in FIG. 15, the password input screen HG3B shown in FIG. 16 and the file name input screen HG3C shown in FIG. 17, respectively.

The job generation portion 101 generates a job for producing an image of the file 6 of the file name designated in Step #8 that is stored in the box 5 designated in Step #8 and registers the job in the active job database DB3 shown in FIG. 8 (No in #9, #11). When the job's turn comes, the job execution control portion 102 reads the file 6 designated in Step #8 and controls the printer device 14, the communication interface 16 or others so as to perform the process for producing the real image data 6b (copy, print, file transmission, FAX transmission or the like) by the condition indicated in the attribution information 6a (#12).

For example, if a job type of the job is “copy” or “print” and the attribution information 6a indicates the job mode (the process condition) “with staples, double sided”, the printer device 14 or the like is controlled so that the document of the real image data 6b of the file 6 is printed by double sided printing and the printed matter is stapled. If the job type is “scan” and the attribution information 6a indicates the job mode “transmission destination=MORIKAWA@ . . . .com”, the communication interface 16 or the like is controlled so that the file 6 is attached to electronic mail and the electronic mail is sent to the electronic mail address.

Note that a program for sending screen data of a screen that is equal to each screen for being displayed on the display device 12 to the personal computer 31 and a program for receiving information entered in the screen from the personal computer 31 are installed in the image forming device 1. Thus, the user can designate the file 6 stored in the box 5 by remote control from his or her personal computer 31 so that the image forming device 1 performs the desired process. In addition, the user can also perform the operation for the job operation process described below from the personal computer 31.

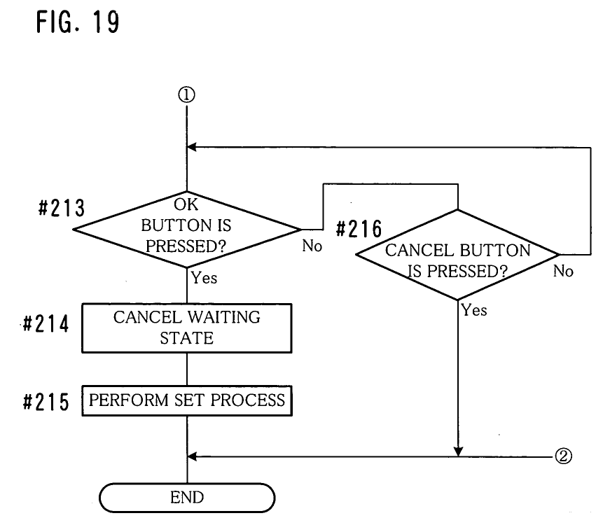

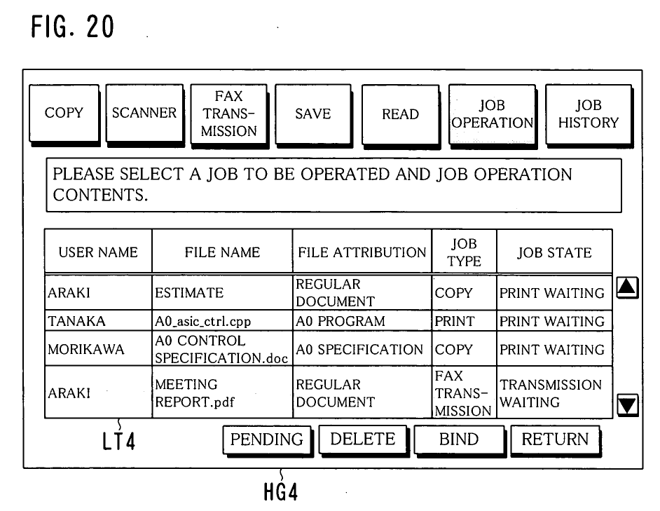

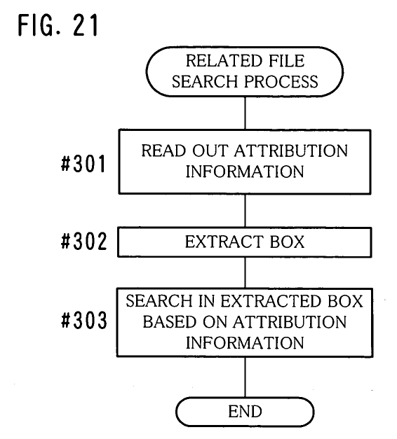

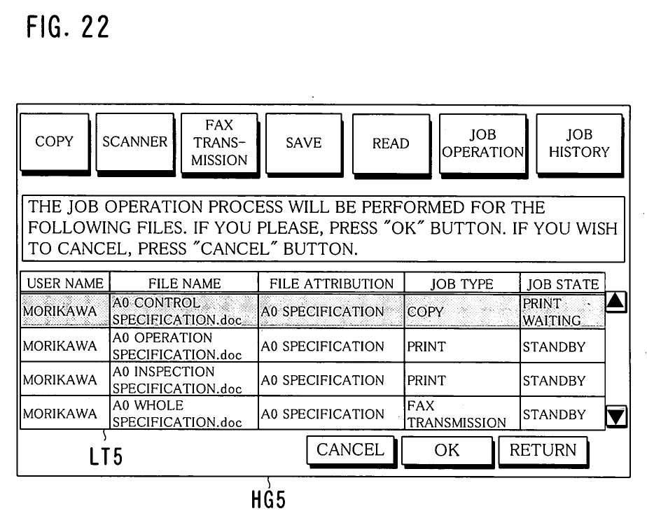

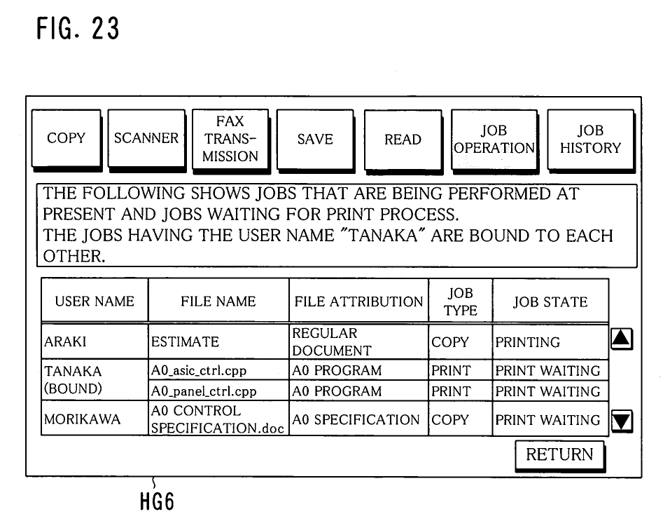

FIGS. 18 and 19 are flowcharts showing an example of a flow of a job operation process in a first embodiment, FIG. 20 shows an example of an active job operation screen HG4, FIG. 21 is a flowchart showing an example of a flow of a related file search process, FIG. 22 shows an example of a file confirmation screen HG5, and FIG. 23 shows an example of a result confirmation screen HG6.

The user can designate a job that is registered in the image forming device 1 and is not processed yet to confirm the file 6 having connection with the job or get output of the file 6 together with the job.

If the user wants to use these functions, the user presses a “job operation” button on the initial menu screen HG1 shown in FIG. 10 (No in #2, No in #3, Yes in #4 of FIG. 9). Then, the image forming device 1 performs the process for realizing these functions in the procedure as shown in FIGS. 18 and 19 (#13).

When the “job operation” button is pressed, the job list generation portion 108 shown in FIG. 7 refers to the active job database DB3 shown in FIG. 8 so as to generate an active job list LT4 that is a list of jobs whose processes are not completed, and the active job operation screen HG4 as shown in FIG. 20 is displayed on the display device 12 (#201 in FIG. 18). Note that it is possible that the jobs cannot be displayed in one screen depending on a screen size. In this case, the user may press a scroll button disposed at the right side of the active job list LT4 to scroll the active job list LT4 for confirming all jobs. This operation can be also applied to other lists including a file list LT5 that will be described later.

If there is a job that the user wants to suspend temporarily, the user presses and selects a line corresponding to the job on the active job list LT4 and then presses a “pending” button. As a result (Yes in #202), the image forming device 1 sets the value “pending” to a job operation flag that is a flag indicating a state (a type) of the job operation process to be performed (#203) and controls the active job database DB3 so that the selected job is not performed (#208).

The file search portion 105 shown in FIG. 7 searches the file 6 having connection with the selected job in the procedure shown in FIG. 21, for example (#209). Namely, the attribution information 6a (see FIG. 4) of the file 6 that is used for performing the job is read out (#301 in FIG. 21), and the box 5 storing the file 6 is extracted (#302). Then, the file 6 having the same file attribution as the file attribution that is set in the read attribution information 6a is searched from the extracted box 5 (#303).

With reference to FIG. 18 again, the file list generation portion 106 shown in FIG. 7 generates the file list LT5 in accordance with the search result by the file search portion 105, and the file confirmation screen HG5 as shown in FIG. 22 is displayed on the display device 12 (#210).

In the file list LT5, the “job state” indicates which state the process (job) based on the file 6 indicated in the line is at present. For example, the “print waiting” means the state where the print job of contents of the file 6 corresponding to the line is registered in the active job database DB3 (see FIG. 8) and is waiting its turn for execution. The “printing” means that the print process is being performed at present based on the file 6 corresponding to the line. The “standby” means that no process having connection with the file 6 corresponding to the line is being performed at present. The “pending” means that though the process (the job) based on the file 6 corresponding to the line is registered in the active job database DB3, execution thereof is postponed until a restart instruction is issued. In addition, the line of the file 6 corresponding to the job selected in the active job list LT4 shown in FIG. 20 is in the selected state in default (for example in a gray display).

The user sees the file confirmation screen HG5 for checking whether or not to set the job (the job in the gray display) to pending. If it can be set to pending, the user presses the “OK” button. In order to stop the pending, the user presses a “cancel” button.

When the “OK” button is pressed (Yes in #213 in FIG. 19), the waiting state controlled in Step #208 shown in FIG. 18 is canceled (#214), and the process that is set in the job operation flag is performed (#215). Namely, the active job database DB3 (see FIG. 8) is updated here so that the job state of the job becomes “pending”. On the other hand, when the “cancel” button is pressed (No in #213, Yes in #216), the job operation flag is reset and execution of the process selected on the active job operation screen HG4 shown in FIG. 20 (i.e., the process for pending the job) is canceled.

When the user wants to stop the execution of the job, the user presses and selects the line corresponding to the job in the active job list LT4 shown in FIG. 20 and presses a “delete” button. As a result (No in #202, Yes in #204), the image forming device 1 sets the value “delete” to the job operation flag (#205) and controls the active job database DB3 so that the selected job is not performed (#208).

The file search portion 105 shown in FIG. 7 searches the file 6 having connection with the selected job in the procedure described above with reference to FIG. 21 (#209), and the file list generation portion 106 displays the file confirmation screen HG5 as shown in FIG. 22 on the display device 12 in accordance with the search result (#210).

The user sees the file confirmation screen HG5 and checks whether or not the execution of the job (the job in the gray display) can be stopped. If it can be stopped, the user presses the “OK” button. In order to stop the pending the user presses the “cancel” button.

When the “OK” button is pressed (Yes in #213 in FIG. 19), the waiting state controlled in Step #208 in FIG. 18 is canceled (#214), and the data of the job is removed from the active job database DB3 (see FIG. 8) (#215). On the other hand, when the “cancel” button is pressed (No in #213, Yes in #216), the job operation flag is reset and the stop process of the job is canceled.

If the user wants to bind the waiting job to another job, the user presses and selects the line corresponding to the waiting job in the active job list LT4 shown in FIG. 20 and presses a “bind” button. As a result (No in #202, No in #204, Yes in #206), the image forming device 1 sets the value “bind” to the job operation flag (#207) and controls the active job database DB3 so that the selected job is not performed (#208).

Similarly to the case of “pending” or “delete”, the file list LT5 indicating the file 6 having connection with the selected job is generated, and the file confirmation screen HG5 as shown in FIG. 22 is displayed on the display device 12 (#209, #210).

The user sees the file confirmation screen HG5 and selects the file 6 to be produced together with the execution of the job (the job in the gray display) by pressing the line that corresponds to the file 6. It is possible to select plural files. The pressed line becomes the gray display. Alternatively, a structure is possible in which all the files 6 searched in Step #209 are selected automatically. After selecting all the files 6 to be produced, the “OK” button is pressed.

As a result (Yes in #213), the waiting state controlled in Step #208 shown in FIG. 18 is canceled (#214), and the following process is performed (#215). Namely, the job generation portion 101 shown in FIG. 7 generates a job for producing the file 6 selected in the file list LT5. Then, the generated job is bound with the job selected in the active job list LT4 to one group. A structure is possible in which the generated job is performed in accordance with the output condition set in the original file 6 (the “job mode” of the attribution information 6a shown in FIG. 4) or is performed in accordance with the output condition of the job selected in the active job list LT4.

Note that if the job type of the job selected in the active job list LT4 is different from the job attribution of the file 6 selected in the file list LT5, it is possible to perform the binding so that the process indicated in the former is performed. For example, if the job type of the job selected in the active job list LT4 is “copy” and the job attribution of the file 6 selected in the file list LT5 is “FAX transmission”, the job attribution of the latter may not be considered so that the job for copying the image of the real image data 6b of the file 6 is generated and the binding is performed. This procedure can be also applied to a second embodiment that will be described below.

If the “cancel” button is pressed (No in #213, Yes in #216), the job operation flag is reset and the binding process is canceled.

When the process in Step #215 is completed, the job list generation portion 108 generates the active job list again in accordance with the result so as to display the result confirmation screen HG6 again. FIG. 23 shows an example of the result confirmation screen HG6 after the binding process is performed in accordance with the instruction of the user having the user name “TANAKA”.

If a button except the “pending” button, the “delete” button and the “bind” button is pressed in the active job operation screen HG4 (No in #202, No in #204, No in #206, Yes in #208 shown in FIG. 18), a process corresponding to the pressed button is performed (#212). Contents of these processes are the same as described in Step #5 shown in FIG. 9.

### Second Embodiment

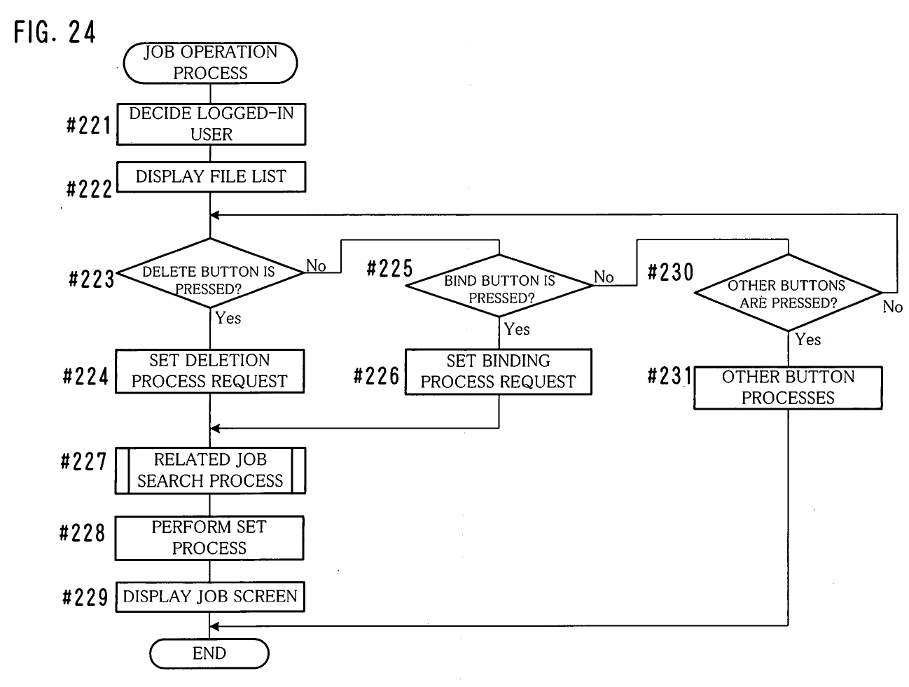

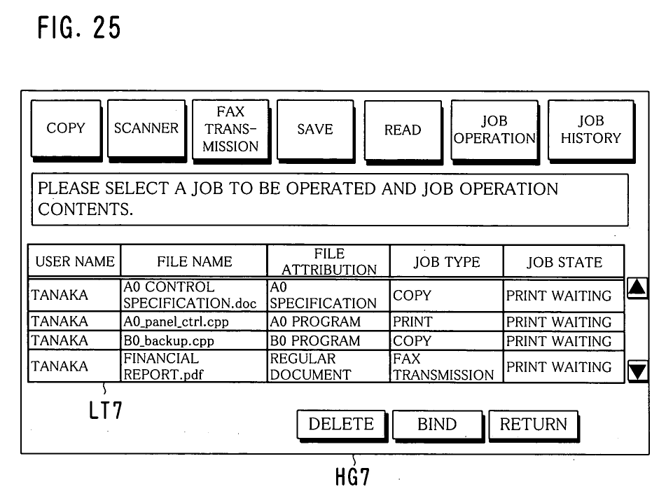

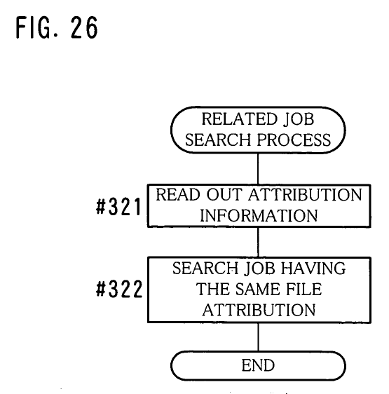

FIG. 24 is a flowchart showing an example of a flow of a job operation process, FIG. 25 shows an example of a file operation screen HG7, and FIG. 26 is a flowchart showing an example of a flow of a related job operation process.

In the first embodiment, if the “job operation” button is selected in the initial menu screen HG1 shown in FIG. 10 (Yes in #4 shown in FIG. 9), the active job list LT4 (see FIG. 20) that is a list of jobs waiting process is displayed for the user, and the pending, deleting or binding process is performed for the job selected by the user in the job list as described with reference to FIGS. 18 and 19. In the second embodiment, a list of the files 6 stored in the box 5 is displayed, and the binding process or the like is performed for the file 6 selected by the user in the list. Hereinafter, the job operation process after the “job operation” button is selected in the second embodiment will be described. Note that a description of a part overlapping the first embodiment will be omitted.

When the “job operation” button is selected (Yes in #4 shown in FIG. 9), the image forming device 1 performs the job operation process in the procedure as shown in FIG. 24, for example (#13).

The user decision portion 109 shown in FIG. 7 decides which user selected the “job operation” button (#221 in FIG. 24). More specifically, if there is a user who is currently operating the operational device 11 or the display device 12 to log in the image forming device 1, it is decided that the user is a “user who selected the “job operation” button”. If there is not such a user, a screen for entering a user name and a password is displayed on the display device 12 so as to request the user to log in the image forming device 1. The password corresponding to the entered user name is retrieved from the user information database DB1 shown in FIG. 5 and is compared with the entered password. If they are identical to each other and the user is authenticated, the log-in of the user to the image forming device 1 is permitted. Then, it is decided that the user who has logged in is the “user who selected the “job operation” button”.

The file search portion 105 searches the file 6 stored in the box 5 of the decided user, and the file list generation portion 106 generates a file list LT7 in accordance with the search result so that the file operation screen HG7 as shown in FIG. 25 is displayed on the display device 12 (#222).

Here, the user selects a process to be performed for the file 6. If the user wants to delete the file 6 from the box 5, the user presses and selects the line of the file 6 to be deleted in the file list LT7 and presses the “delete” button. As a result (Yes in #223), a value “delete” is set to the job operation flag (#224), and the job search portion 107 searches the job corresponding to the selected file 6 in the procedure as shown in FIG. 26 (#227).

Namely, the attribution information 6a (see FIG. 4) of the file 6 is read out (#321 in FIG. 26), and a job having connection with the selected file 6 is searched from the active job database DB3 (see FIG. 8) (#322). In this embodiment, as the job having connection with the file 6, a job is searched that has the same file attribution as the file attribution of the attribution information 6a of the file 6 and is instructed by the user who logs in.

With reference to FIG. 24 again, a process indicated in the job operation flag is performed for the file 6 selected from the file list LT7 (#228). Here, the file 6 is deleted (erased) from the box 5. Simultaneously, the job list generation portion 108 generates the active job list in accordance with the search result and displays the list on the display device 12 (#229).

If the user wants to bind the file 6 with a waiting job for output, the user presses and selects the line of the file 6 in the file list LT7 and presses the “bind” button. Then (No in #223, Yes in #225), the value “bind” is set to the job operation flag (#226), and a job having connection with the selected file 6 is searched in the same manner as in the case of “delete” (#227).

The job generation portion 101 shown in FIG. 7 generates a job of the output process of the selected file 6 so that the job is bound to the job searched in Step #227 and is registered in the active job database DB3 (#228). The job list generation portion 108 generates the active job list again, and a screen similar to the result confirmation screen HG6 shown in FIG. 23 is displayed on the display device 12 (#229). Note that if plural jobs are found in Step #227, the user may select a job to be bound.

If a button except the “delete” button and the “bind” button is pressed in the file operation screen HG7 (No in #223, No in #225, Yes in #230), a process corresponding to the pressed button is performed (#231). Contents of the process are the same as the contents described in Step #5 shown in FIG. 9.

According to the first and the second embodiments, usability for handling jobs stored in the queue or data stored in the box can be improved compared with the conventional method. For example, according to the first embodiment, a file 6 having connection with the job stored in the queue can be searched by a simple operation. The job for producing the image of the file 6 can be bound to the job waiting for execution and having connection with the job by a simple operation. In addition, according to the second embodiment, a job having connection with the file 6 stored in the box can be found by a simple operation. Furthermore, the job for producing the image of the file 6 can be bound to the job waiting for execution and having connection with the file 6 by a simple operation.

It is possible to realize both the job operation process in the first embodiment (Step #13 shown in FIG. 9) and the job operation process in the second embodiment by one image forming device 1. In this case, the initial menu screen HG1 shown in FIG. 10 may include the “job operation” button corresponding to the job operation process in the first embodiment and the “job operation” button corresponding to the job operation process in the second embodiment, for example. Then, the image forming device 1 performs the process described in FIG. 18 when the former is pressed, while it performs the process described in FIG. 24 when the latter is pressed.

Though the file attribution (see FIG. 4) is used in the first embodiment as a search key for searching the file 6 having connection with the job selected by the user, other information may be used. For example, it is possible to search the file 6 in which the same output condition (the job mode shown in FIG. 4) is set as the output condition of the job as the file 6 having connection. In addition, though the file attribution is used as the search key for searching the job having connection with the file 6 selected by the user in second embodiment, too, it is possible to use other information such as the output condition for the search key.

Though the search range of the file 6 having connection with the job selected by the user is regarded to be the box 5 of the user who registered the job in the queue in the first embodiment, it may be other box 5. For example, the box 5 in which the file 6 necessary for execution of the job (i.e., data to be the base of the job) is stored may be regarded to be the search range.

Though the file sharing system FS shown in FIG. 1 includes only one image forming device 1, it is possible to provide plural image forming devices.

The present invention can be applied not only to an MFP but also to a FAX terminal, a printer device, an image reading device or the like. Alternatively, it can be applied to a server that is connected to a FAX modem, a printer device and an image reading device.

Furthermore, the whole or a part of the file sharing system FS or the image forming device 1, contents of the processes, orders of the processes, output conditions, the structure of the attribution information 6a or the like can be modified if necessary in accordance with the spirit of the present invention.

The present invention can be used eligibly for improving usability of an image output device such as an MFP.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A data management device for managing data that are used for performing a process, the device comprising:
a data storage portion for storing the data;
a job information storage portion for storing job information about a job of the process;
a job list display portion for performing a process for displaying a job list screen in accordance with the job information stored in the job information storage portion, the job list screen being used for letting a user select a job;
a data searching portion for searching data having connection with the job selected by the user on the job list screen from the data stored in the data storage portion in accordance with the job information of the job; and
a data list display portion for performing a process for displaying a data list screen that is a list of the data searched by the data searching portion.

2. A data management device, for managing data that are used for performing a process, the device comprising:
a data storage portion for storing the data;
a job information storage portion for storing job information about a job of the process;
a data list display portion for performing a process for displaying a data list screen for letting a user select any of the data stored in the data storage portion;
a job searching portion for searching a job having connection with the data selected by the user on the data list screen in accordance with the job information stored in the job information storage portion; and
a job process portion for performing a process designated by the user for the job searched by the job searching portion.

3. An image output device comprising:
a data storage portion for storing output data that are data for outputting an image;
a job information storage portion for storing job information about a job of an image output process;
a job list display portion for performing a process for displaying a job list screen in accordance with the job information stored in the job information storage portion, the job list screen being used for letting a user select a job;
a data searching portion for searching output data having connection with the job selected by the user on the job list screen from the output data stored in the data storage portion in accordance with the job information of the job; and
a data list display portion for performing a process for displaying a data list screen that is a list of the output data searched by the data searching portion.

4. The image output device according to claim 3, further comprising a job generation portion for generating the job about an image of the output data searched by the data searching portion, wherein
the job information storage portion stores the job information of the job that is not performed yet, and
the job information storage portion stores the job generated by the job generation portion after binding the same to the job selected by the user on the job list screen.

5. The image output device according to claim 3, further comprising a job generation portion for generating the job about an image of the output data stored in the data storage portion, wherein
the job information storage portion stores the job information of the job that is not performed yet, and
when the user selects any of the output data on the data list screen,
the job generation portion generates the job about the image of the output data, and
the job information storage portion stores the generated job after binding the same to the job selected by the user on the job list screen.

6. The image output device according to claim 3, wherein
the data storage portion has a plurality of storage areas, and
the data searching portion searches the output data in a search range that is the storage area of the user who registered the job indicated in the job information.

7. An image output device, comprising:
a data storage portion for storing output data that are data for outputting an image;
a job information storage portion for storing job information about a job of an image output process;
a data list display portion for performing a process for displaying a data list screen for letting a user select any of the output data stored in the data storage portion;
a job searching portion for searching a job having connection with the output data selected by the user on the data list screen in accordance with the job information stored in the job information storage portion; and
a job process portion for performing a process designated by the user for the job searched by the job searching portion.

8. An image output device, comprising:
a data storage portion for storing output data that are data for outputting an image;
a job information storage portion for storing job information about a job of an image output process;
a data list display portion for performing a process for displaying a data list screen for letting a user select any of the output data stored in the data storage portion;
a job searching portion for searching a job having connection with the output data selected by the user on the data list screen in accordance with the job information stored in the job information storage portion; and
a job list display portion for performing a process for displaying a job list screen that is a list of the searched jobs.

9. The image output device according to claim 7, further comprising a job generation portion for generating the job about an image of the output data stored in the data storage portion, wherein
the job information storage portion stores the job information of the job that is not performed yet, and
when the user selects any of the output data on the data list screen,
the job generation portion generates the job about the image of the output data, and
the job process portion binds the generated job to the job having connection with the output data searched by the job searching portion

10. A method for managing data in a data management device including a data storage portion for storing data that are used for performing a process and a job information storage portion for storing job information about a job of the process, the method comprising:
a step for performing a process for displaying a job list screen in accordance with the job information stored in the job information storage portion, the job list screen being used for letting a user select a job;
a step for searching data having connection with the job selected by the user on the job list screen from the data stored in the data storage portion in accordance with the job information of the job; and
a step for performing a process for displaying a data list screen that is a list of the searched data.

11. A method for managing data in a data management device including a data storage portion for storing data that are used for performing a process and a job information storage portion for storing job information about a job of the process, the method comprising:
a step for performing a process for displaying a data list screen for letting a user select any of the data stored in the data storage portion;
a step for searching a job having connection with the data selected by the user on the data list screen in accordance with the job information stored in the job information storage portion; and
a step for performing a process designated by the user for the searched job.

12. A method for managing data in a data management device including a data storage portion for storing data that are used for performing a process and a job information storage portion for storing job information about a job of the process, the method comprising:
a step for performing a process for displaying a data list screen for letting a user select any of the data stored in the data storage portion;
a step for searching a job having connection with the data selected by the user on the data list screen in accordance with the job information stored in the job information storage portion; and
a step for performing a process for displaying a job list screen that is a list of the searched jobs.

13. A computer program product for a use in a computer that can access a data storage portion for storing data that are used for performing a process and a job information storage portion for storing job information about a job of the process, the computer program product makes the computer execute the process comprising the steps of:
displaying a job list screen in accordance with the job information stored in the job information storage portion, the job list screen being used for letting a user select a job;
searching data having connection with the job selected by the user on the job list screen from the data stored in the data storage portion in accordance with the job information of the job; and
displaying a data list screen that is a list of the searched data.

14. A computer program product for a use in a computer that can access a data storage portion for storing data that are used for performing a process and a job information storage portion for storing job information about a job of the process, the computer program product makes the computer execute the process comprising the steps of:
displaying a data list screen for letting a user select any of the data stored in the data storage portion;
searching a job having connection with the data selected by the user on the data list screen in accordance with the job information stored in the job information storage portion; and
displaying a job list screen that is a list of the searched jobs.
